(19) United States
(12) Patent Application Publication
(10) Pub. No.: US 2010/0290151 A1
(43) Pub. Date: Nov. 18, 2010

(54) DISK CONTROLLER, DISK DRIVE DEVICE, AND DISK CONTROL METHOD

(75) Inventors: Yosuke KONDO, Ome-shi (JP); Kenji YOSHIDA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/715,234

(22) Filed: Mar. 1, 2010

(30) Foreign Application Priority Data
May 15, 2009 (JP) 2009-119133

(51) Int. Cl. G11B 15/18

(52) U.S. Cl. 360/71

(57) ABSTRACT

According to one embodiment, a disk controller includes a reader, a selector, and a combining module. The reader performs, when retrying reading data from a magnetic disk, a plurality of read operations with respect to the same area on the magnetic disk while offsetting a head that reads data from the magnetic disk. The selector selects likely read data from a plurality of pieces of read data obtained as results of the read operations performed by the reader based on a predetermined index with respect to each of data lengths shorter than the data length of the area. The combining module combines pieces of read data selected for the data lengths, respectively.

### CROSS-REFERENCE TO RELATED APPLICATIONS

This application is based upon and claims the benefit of priority from Japanese Patent Application No. 2009-119133, filed on May 15, 2009, the entire contents of which are incorporated herein by reference.

### BACKGROUND

1. Field

One embodiment of the invention relates to a disk controller that reads data from a magnetic disk, a disk drive device, and a disk control method.

2. Description of the Related Art

Hard disk drive devices have been used to store video data and audio data.

A hard disk drive device writes data in units of physical sectors. If an error occurs in reading data from a physical sector, the error is corrected by an error correcting code (ECC). If the error cannot be corrected by the ECC, the data is read again from the same sector. This process is referred to as “retry”. The uncorrectable error can be caused by various factors such as, for example, influence or interference from an adjacent track.

In a conventional retry technique, a magnetic head is off-tracked or moved off a track by a predetermined amount toward the adjacent track, and data is read again. When the data can be read properly, processing is performed according to the next instruction (a read or write command).

For example, Japanese Patent Application Publication (KOKAI) No. 2000-123498 discloses a conventional technology related to the retry technique. According to the conventional technology, if a mean square error (MSE) obtained by decoding using a Viterbi algorithm is a predetermined value or less upon performing a retry operation, data is used as proper data.

With the conventional technology, when a retry operation is performed with respect to the same physical sector by shifting or offsetting the magnetic head, there is the case that all data read by the retry operation are erroneous. Even such erroneous data read by a retry operation may be read properly in a section of the physical sector.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hardware configuration of a hard disk drive (HDD) device according to an embodiment of the invention;

FIG. 2 is an exemplary conceptual diagram of the structure of a magnetic disk in the embodiment;

FIG. 3 is an exemplary schematic diagram for explaining the case where retry operation is performed when an uncorrectable error occurs due to a cross-talk in the HDD device in the embodiment;

FIG. 4 is an exemplary block diagram of a configuration for processing read data in the read/write block of the HDD device in the embodiment;

FIG. 5 is an exemplary chart of changes in noise amount in each section with respect to each read result in the HDD device in the embodiment;

FIG. 6 is an exemplary schematic diagram for explaining retry operation performed when the head of the HDD device is displaced at a write operation in the embodiment; and

FIG. 7 is an exemplary flowchart of the process of reading data a plurality of times based on retry in the HDD device in the embodiment.

### DETAILED DESCRIPTION

Various embodiments according to the invention will be described hereinafter with reference to the accompanying drawings. In general, according to one embodiment of the invention, a disk controller comprises a reader, a selector, and a combining module. The reader is configured to perform, when retrying reading data from a magnetic disk, a plurality of read operations with respect to the same area on the magnetic disk while offsetting a head that reads data from the magnetic disk. The selector is configured to select likely read data from a plurality of pieces of read data obtained as results of the read operations performed by the reader based on a predetermined index with respect to each of data lengths shorter than the data length of the area. The combining module is configured to combine pieces of read data selected for the data lengths, respectively.

According to another embodiment of the invention, a disk drive device comprises a reader, a selector, and a combining module. The reader is configured to perform, when retrying reading data from a magnetic disk, a plurality of read operations with respect to the same area on the magnetic disk while offsetting a head that reads data from the magnetic disk. The selector is configured to select likely read data from a plurality of pieces of read data obtained as results of the read operations performed by the reader based on a predetermined index with respect to each of data lengths shorter than the data length of the area. The combining module is configured to combine pieces of read data selected for the data lengths, respectively.

According to still another embodiment of the invention, there is provided a disk control method comprising: a reader performing, when retrying reading data from a magnetic disk, a plurality of read operations with respect to the same area on the magnetic disk while offsetting a head that reads data from the magnetic disk; a selector selecting likely read data from a plurality of pieces of read data obtained as results of the read operations performed by the reader based on a predetermined index with respect to each of data lengths shorter than the data length of the area; and a combining module combining pieces of read data selected for the data lengths, respectively.

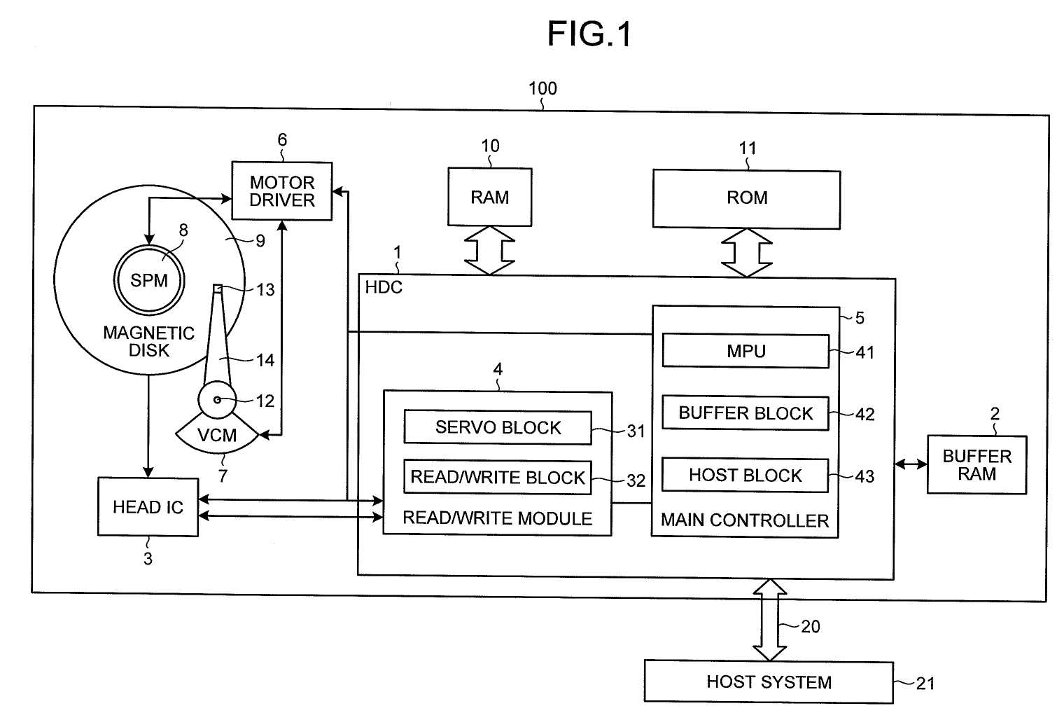

FIG. 1 is a block diagram of a hardware configuration of a hard disk drive (HDD) device 100 according to an embodiment of the invention. As illustrated in FIG. 1, the HDD device 100 comprises a hard disk controller (HDC) 1, a buffer random access memory (RAM) 2, a motor driver 6, a voice coil motor (VCM) 7, a spindle motor (SPM) 8, a magnetic disk 9, a RAM 10, a read only memory (ROM) 11, a magnetic head 13, an arm 14, a spindle 12, and a head integrated circuit (IC) 3. The HDD device 100 is connected to a host system 21 via a transmission path 20.

The SPM 8 is a motor that steadily rotates the magnetic disk 9. The VCM 7 comprises a magnet and a drive coil (both not illustrated), and is driven by power supplied from the motor driver 6 to move the magnetic head 13 to a desired position.

The motor driver 6 controls current that flows through the SPM 8 and the VCM 7 to drive them.

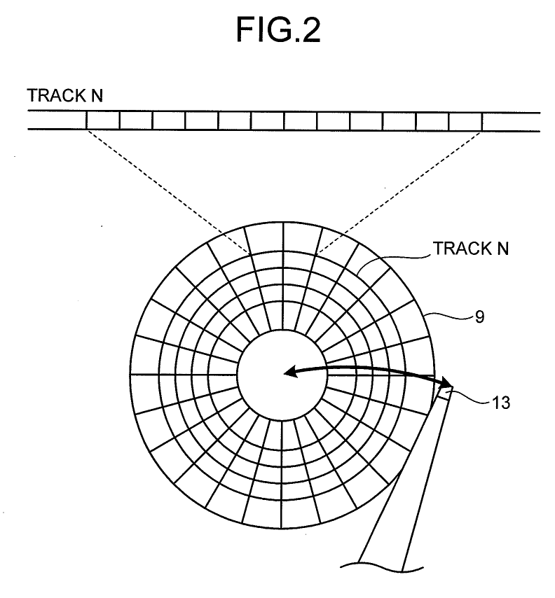

The magnetic disk 9 is provided with a readable/writable data area. FIG. 2 is a conceptual diagram of the structure of the magnetic disk 9. As illustrated in FIG. 2, a track is formed on the magnetic disk 9 with respect to each of the different radii. As with a track N illustrated in FIG. 2, each track has an area (data area) to store data received from the host system 21. The data area includes a plurality of sectors. With this configuration of the magnetic disk 9, when moving along the radial direction of the magnetic disk 9, the magnetic head 13 scans a sector of a track. While scanning the sector on the magnetic disk 9, the magnetic head 13 reads data from or writes data to the sector.

Referring back to FIG. 1, the magnetic head 13 is supported by the arm 14. The magnetic head 13 reads the position information of a track from servo data and also scans the magnetic disk 9 to read or write data. The arm 14 is driven by the VCM 7 and rotates about the spindle 12 to move the magnetic head 13 in the radial direction of the magnetic disk 9.

The head IC 3 has the function of, for example, amplifying a weak signal read by the magnetic head 13.

The ROM 11 stores a control program used by the HDC 1 (for example, a microprocessing unit (MPU) 41). The RAM 10 is used as a work area where the HDC 1 (for example, the MPU 41) stores a variable prime number and the like.

The HDC 1 is an integrated circuit (IC) designed to control the HDD device 100. The HDC 1 comprises a read/write module 4 and a main controller 5.

The main controller 5 comprises the MPU 41, a buffer block 42, and a host block 43.

The host block 43 controls an interface to the host system 21. The buffer block 42 controls the buffer RAM 2.

The MPU 41 performs read/write operation. The MPU 41 searches for a track to read data from or write data to the track, and manages the position where the data is to be read/written.

The read/write module 4 comprises a servo block 31 and a read/write block 32. The read/write module 4 controls read/write operation by the magnetic head 13 according to an instruction from the main controller 5.

The servo block 31 mainly performs signal processing necessary to position the magnetic head 13. The read/write block 32 performs signal processing necessary for the magnetic head 13 to read/write data. That is, data read/write operation is controlled based on a signal from the read/write block 32.

The buffer RAM 2 stores read data and the like. The data stored in the buffer RAM 2 is output to the host system 21.

Described below is control based on a read request. An analog signal is read from the magnetic head 13 according to a control signal from the read/write block 32 when the servo block 31 positions the magnetic head 13. The analog signal is amplified by the head IC 3 and is sent to the read/write module 4 of the HDC 1. The read/write module 4 decodes the amplified analog signal. The main controller 5 generates data to be transmitted to the host system 21 from the decoded analog signal. The data is once stored in the buffer RAM 2, and then transmitted to the host system 21. The configuration of the read/write module 4 to decode the analog signal will be described later.

Described below is control based on a write request. Data transmitted from the host system 21 to the main controller 5 is once stored in the buffer RAM 2, and then sent to the read/write module 4 by the main controller 5. The read/write module 4 encodes the data. The data is written to the magnetic disk 9 by the magnetic head 13 through the head IC 3.

An uncorrectable error sometimes occurs while the magnetic head 13 is reading data from a physical sector of the magnetic disk 9. An uncorrectable error may occur, for example, due to a cross-talk (interference from an adjacent track signal) during a read operation, when the data is recorded on a position near the adjacent track due to the displacement of the magnetic head 13 during a write operation, or the like.

In this case, in the HDD device 100 of the embodiment, data is read from one track a plurality of times during retry by shifting or offsetting the magnetic head 13 little by little. More specifically, if an uncorrectable error occurs while data is being read from a track under the control of the read/write block 32 of the read/write module 4, the read operation is retried by shifting or offsetting the magnetic head 13. If an uncorrectable error still occurs, the read operation is retried by offsetting the magnetic head 13 in a different direction.

In the HDD device 100 of the embodiment, if an uncorrectable error occurs in all normal read and retry read operations, data with less noise are selected from data read by the normal read and retry read operations for sections, respectively. The selected data are combined to generate data having no error or correctable error to thereby improve the retry decoding performance when an uncorrectable error occurs.

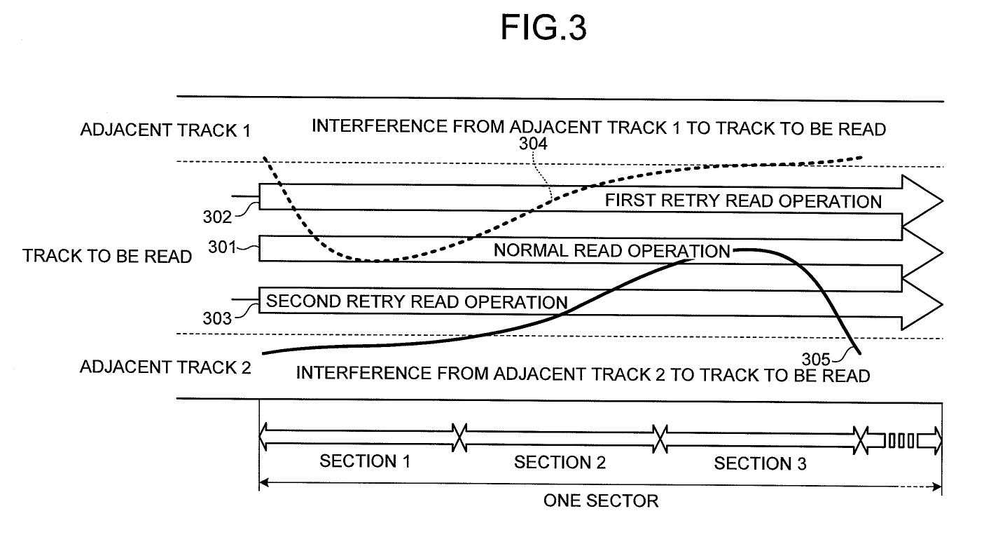

FIG. 3 is a schematic diagram for explaining the case where retry operation is performed when an uncorrectable error occurs due to a cross-talk. FIG. 3 illustrates an example in which an uncorrectable error occurs in a normal read operation 301. In this case, in the HDD device 100 of the embodiment, retry operation is performed to read data from the magnetic disk 9. At that time, the servo block 31 offsets the magnetic head 13, and the read/write block 32 reads data from the same sector a plurality of times.

According to the embodiment, after the servo block 31 offsets the magnetic head 13, the read/write block 32 performs a first retry read operation 302 and a second retry read operation 303.

While the retry read operation is described by way of example as being performed twice in addition to the normal read operation, it is not so limited. The retry read operation may be performed once, three times, or more.

More specifically, in the example of FIG. 3, a track to be read is affected by a cross-talk from an adjacent track 1 as indicated by a line 304 and a cross-talk from an adjacent track 2 as indicated by a line 305. Accordingly, in the HDD device 100, an uncorrectable error occurs in reading the center of the track to be read by the normal read operation 301. Therefore, the read/write block 32 performs retry operation by offsetting the magnetic head 13 to shift the position to be read by the magnetic head 13.

In the example of FIG. 3, because of the influence of the cross-talks as indicated by the lines 304 and 305, in a section 1 of one sector, data read by the second retry read operation 303 is likely to have the least noise. Further, data read by the normal read operation 301 and data read by the first retry read operation 302 are likely to have the least noise in sections 2 and 3, respectively. The read/write block 32 of the embodiment selects and extracts data with less noise for respective sections, and combines the extracted data to generate data read from the one sector.

Incidentally, the number of sections in a sector is assumed to be set appropriately depending on a magnetic disk to be used.

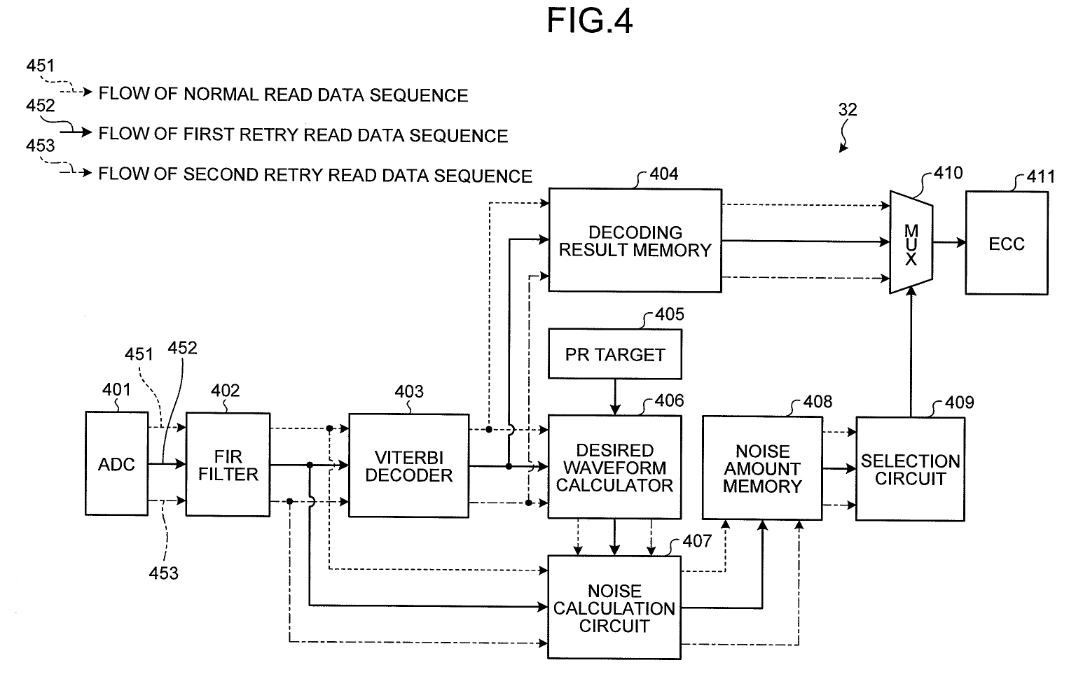

FIG. 4 is a block diagram of a configuration for processing read data in the read/write block 32. As illustrated in FIG. 4, the read/write block 32 comprises an analog-to-digital converter (ADC) 401, a finite impulse response (FIR) filter 402, a Viterbi decoder 403, a decoding result memory 404, a partial response (PR) target 405, a desired waveform calculator 406, a noise calculation circuit 407, a noise amount memory 408, a selection circuit 409, a multiplexer (MUX) 410, and an error correcting code (ECC) 411. The read/write block 32 of the embodiment configured as above stores decoding results obtained by a Viterbi algorithm in read operations, respectively. The read/write block 32 selects a decoding result (decoded data) with less noise from the stored decoding results with respect to each of sections obtained by dividing one sector and combines selected decoding results, thereby outputting the combined data.

The read/write block 32 of the embodiment employs partial response maximum likelihood (PRML) as an algorithm for read signal processing. That is, through processing by the FIR filter 402 and the Viterbi decoder 403, data read from the magnetic disk 9 is determined to be “1” or “0”.

The ADC 401 performs the sampling of a signal amplified by the head IC 3, and generates a read data sequence.

The term “read data sequence” as used herein refers to data indicating the transition of data read by the magnetic head 13 from a physical sector to be read.

There are flows of read data sequences corresponding to the number of read operations performed by the magnetic head 13 with respect to the same physical sector. In the embodiment, for example, there are a flow 451 of a normal read data sequence, a flow 452 of a first retry read data sequence, and a flow 453 of a second retry read data sequence as illustrated in FIG. 4.

The FIR filter 402 performs filtering on each read data sequence for waveform equalization.

The Viterbi decoder 403 performs maximum likelihood decoding (hereinafter, “Viterbi decoding”) on the waveform-equalized read data sequence. With this, a hard decision is made with respect to each read data sequence, and thereby the most likely data sequence is generated. Thus, an error is corrected to a certain extent.

The decoding result memory 404 stores the result of the hard decision obtained by the Viterbi decoder 403 for each read data sequence (Viterbi decoding result for each read data sequence). The decoding result memory 404 of the embodiment is only required to have the capacity capable of storing three read data sequences corresponding to one sector.

The PR target 405 stores a parameter used for filtering by the FIR filter 402.

The desired waveform calculator 406 performs a convolution operation on each Viterbi-decoded read data sequence using the parameter stored in the PR target 405 to calculate a desired waveform for each read data sequence. The term “desired waveform” as used herein refers to an original waveform reproduced from a Viterbi decoding result, i.e., a convoluted waveform signal obtained by the convolution operation.

By comparing the original signal reproduced from a Viterbi decoding result with an actual signal, it is possible to determine whether each Viterbi-decoded read data sequence is appropriate. In other words, if the difference between the original signal reproduced from a Viterbi decoding result and the actual signal is large, it means that the Viterbi-decoded read data sequence is likely to be erroneous.

The noise calculation circuit 407 calculates a noise amount for each read data sequence based on the difference between the calculated desired waveform and the read data sequence, the waveform of which has been equalized by the FIR filter 402 and which is yet to be subjected to Viterbi decoding.

Described below is how to calculate the noise amount. It is defined that N_{w} represents a total noise amount in a section w (w is a numeral value such as 1 or 2 specifying a section in a sector) read by normal read or retry read operation. In the section w, sampling points k are present from a to b where the difference is obtained between a desired waveform and a waveform-equalized read data sequence. In such a case, a noise amount nₖ at a sampling point k (a to b) is represented by Equation 1 as follows:

nₖ=yₖ−xₖ (1)

where yₖ is a read data sequence the waveform of which has been equalized by the FIR filter 402 at the sampling point k, and the xₖ is a desired waveform at the sampling point k.

A noise amount at each sampling point can be calculated based on the difference between a read data sequence the waveform of which has been equalized by the FIR filter 402 and a desired waveform obtained by a convolution operation. After the calculation of the noise amount nₖ at the sampling point k, the total noise amount N_{w} in the section w is calculated by Equation 2 as follows:

$${N}_{w} = {\sum }_{k = a}^{b} \vert {n}_{k} \vert \qquad ( 2 )$$

By Equation 2, an appropriate read data sequence can be specified for each section from the total noise amount N_{w} with respect to each read result (read data sequence).

The noise amount memory 408 stores the calculated total noise amount with respect to each read result (read data sequence). The noise amount memory 408 of the embodiment is only required to have the capacity capable of storing total noise amounts of read data sequences (read data sequences corresponding to the number of read operations) for one sector.

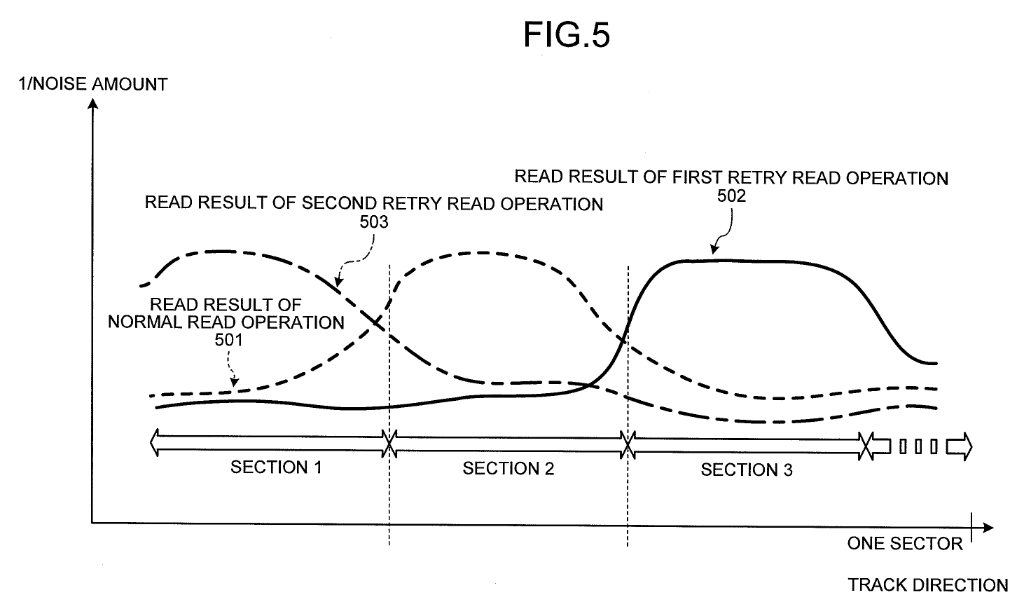

FIG. 5 is a chart of changes in noise amount in each section with respect to each read result. In FIG. 5, the vertical axis represents the inverse number of a calculated noise amount, and the horizontal axis represents a position in a sector. It is assumed herein that the noise illustrated in FIG. 5 is caused by the influence of the cross-talk illustrated in FIG. 3. That is, in each read result, a point with low noise is less affected by the cross-talk, while a point with high noise is more affected by the cross-talk.

In the HDD device 100 of the embodiment, from among read results of normal read and retry read operations, a read result indicating the least noise is selected with respect to each section based on total noise amounts calculated for each section. A Viterbi-decoded read data sequence corresponding the selected read result is output to a latter circuit (for example, the MUX 410 or the like).

In the example of FIG. 5, the selection circuit 409, which will be described later, selects a read result 503 of the second retry read operation, a read result 501 of the normal read operation, and a read result 502 of the first retry read operation for the sections 1 to 3, respectively. Thus, a decoding result with little influence of the cross-talk can be obtained.

Referring back to FIG. 4, the selection circuit 409 selects a read data sequence with the least noise, i.e., the most likely read data sequence as a read result, with respect to each section from the total noise amounts of read results (read data sequences) calculated for the section. While the noise amount is described herein as a predetermined index, this is by way of example only and other values may be used as the index.

The MUX 410 combines Viterbi decoding results of read data sequences selected by the selection circuit 409 for sections, respectively, from decoding results of read data sequences stored in the decoding result memory 404, and outputs it to the ECC 411 as the decoding result of a read data sequence read from a physical sector.

The ECC 411 detects and corrects an error of the input Viterbi decoding result of the read data sequence, and outputs it to the main controller 5 illustrated in FIG. 1.

Incidentally, the HDD device 100 of the embodiment needs memories (1) corresponding to 1 to 2 sectors in the FIR output system, (2) corresponding to the number of retry operations in the Viterbi output system (the decoding result memory 404), and (3) corresponding to the number of retry operations in the noise system (the noise amount memory 408).

Incidentally, HDD devices that perform low-density parity-check (LDPC) coding as the ECC 411 are increasingly used at present. Such an HDD device needs a memory capable of storing soft-decided Viterbi decoding outputs for several to several tens of sectors to perform the pipeline process of Viterbi decoding and LDPC decoding, to absorb the latency due to decoding delay in the LDPC decoding, or the like.

Further, such an HDD device needs a huge memory for storing mid-operation results of the LDPC decoding. In the HDD device 100 of the embodiment, practically, all the memory areas are not used in retry operation. Therefore, part of the memory area prepared for LDPC coding can be used as the memories (1) to (3) necessary for the HDD device 100 of the embodiment.

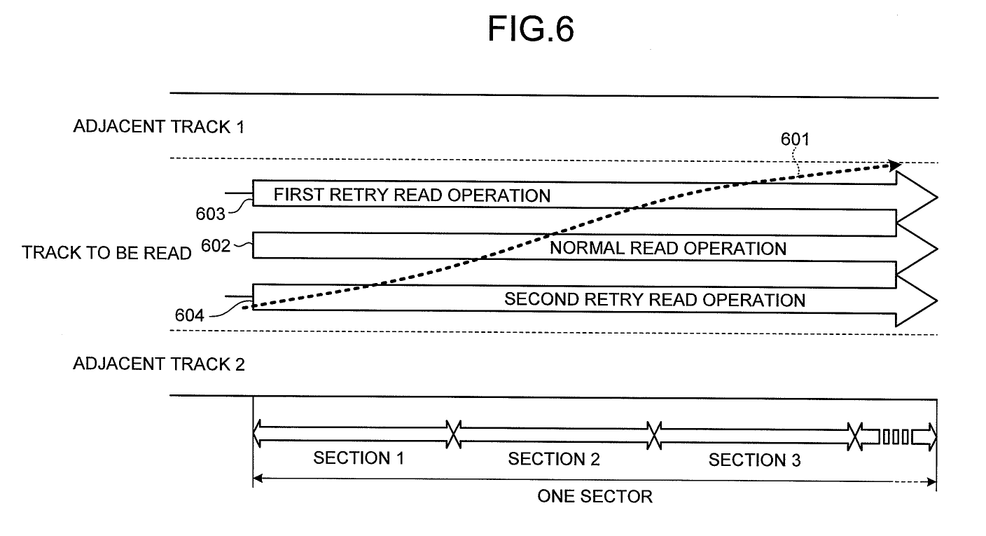

Besides, the embodiment can be applied not only to the case where retry operation is performed due to the influence of cross-talk but also, for example, to the case where retry operation is performed because the head is displaced at a write operation. FIG. 6 is a schematic diagram for explaining retry operation performed when the head of the HDD device 100 is displaced at a write operation. As illustrated in FIG. 6, when the magnetic head 13 moves as indicated by a line 601 while writing data, the read/write block 32 retries a read operation a plurality of times as the servo block 31 is shifting or offsetting the magnetic head 13. Thus, in addition to a normal read operation 602, retry read operations 603 and 604 are performed. After that, as in the case of the retry operation due to the influence of cross-talk, Viterbi decoding is performed on read data sequences obtained by the read operations. Then, the noise amounts are obtained from the results of the Viterbi decoding, and only decoding results with low noise are selected. With this, even if the magnetic head 13 is displaced while writing data, the decoding performance can be improved.

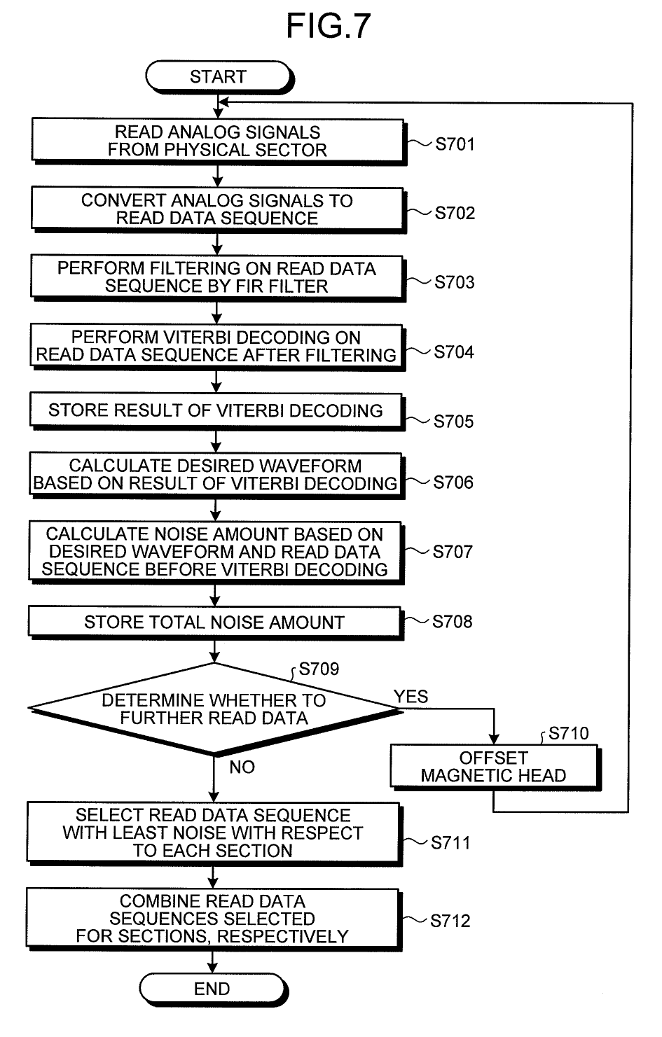

A description will be given of the process of reading data a plurality of times based on retry in the HDD device 100 of the embodiment. FIG. 7 is a flowchart of the process of reading data a plurality of times based on retry in the HDD device 100 of the embodiment. In the example of FIG. 7, it is assumed that an uncorrectable error occurs in both normal read and retry read operations.

First, the read/write block 32 controls the magnetic head 13 to read analog signals from a physical sector on the magnetic disk 9 through the head IC 3 (S701).

The ADC 401 converts the analog signals received from the head IC 3 to a read data sequence (S702).

Thereafter, the FIR filter 402 performs filtering on the read data sequence to equalize the waveform (S703).

The Viterbi decoder 403 then performs Viterbi decoding on the read data sequence the waveform of which has been equalized (S704). The result of the Viterbi decoding on the read data sequence is stored in the decoding result memory 404 (S705).

The desired waveform calculator 406 performs a convolution operation on the Viterbi-decoded read data sequence referring to the PR target 405 to calculate a desired waveform (S706).

The noise calculation circuit 407 calculates a noise amount based on the calculated desired waveform and the read data sequence, the waveform of which has been equalized by the FIR filter 402 and which is yet to be subjected to the Viterbi decoding (S707).

The noise amount memory 408 stores a calculated total noise amount (S708).

After that, the read/write module 4 determines whether to further read data from the physical sector (S709). When the read/write module 4 determines to further read data from the physical sector (Yes at S709), the servo block 31 shifts or offsets the magnetic head 13 (S710). Then, the read control is performed again from 5701. It is assumed herein that a retry read operation is performed twice in addition to a normal read operation.

On the other hand, when the read/write module 4 determines not to further read data from the physical sector (No at S709), the selection circuit 409 selects a decoding result of a read data sequence with the least noise with respect to each section (S711). Subsequently, the MUX 410 combines decoding results of read data sequences selected for sections, respectively, and outputs it as the decoding result of the read data sequence of the physical sector (S712).

Thus, decoding results of read data sequences with less noise are selected for sections, respectively, and are combined to be output.

While the retry read operation is described by way of example as being performed twice in addition to the normal read operation, it is not so limited. The retry read operation may be performed once, three times, or more. The number of retry read operations may be determined based on the memory capacity of the HDD device 100 for storing decoding results of read data sequences and noise.

It is assumed herein that one sector is divided into sections each having a predetermined data length; however, the data length may be dynamically changed.

As described above, according to the embodiment, the HDD device 100 combines read data sequences with less noise selected for sections, respectively, and thereby outputs a read data sequence with low noise for one sector. Thus, the likelihood of error correction is increased when a read operation is retried.

According to the embodiment, even if a signal component is attenuated due to the influence of cross-talk or record position displacement at a write operation and therefore the error rate degrades, the error rate can be improved by the retry operation.

According to the embodiment, a Viterbi decoding result of a read data sequence is selected based on the difference between the read data sequence after filtering and a desired waveform signal. With this, an appropriate Viterbi decoding result can be selected compared to conventional technologies.

The embodiment is not limited as described above, but may be variously modified. A description will be given of an example of a modification of the embodiment.

In the embodiment described above, while a noise amount is used as the difference between a read data sequence after filtering and a desired waveform signal, other parameters may be used. For example, a signal-to-noise (S/N) ratio may be applied. In this case, since a noise amount can be calculated in the same manner as described above, the S/N ratio can be calculated.

A parameter other than the noise amount and the S/N ratio may be calculated as the difference. For example, a signal power may be calculated as the difference between a read data sequence after filtering and a desired waveform signal.

The control program executed on the HDD device 100 of the embodiment may be provided as being stored in advance in ROM or the like.

The control program may also be provided as being stored in a computer-readable storage medium, such as a compact disk read-only memory (CD-ROM), a flexible disk (FD), a compact disc-recordable (CD-R), or a digital versatile disc (DVD), in an installable or executable format.

The control program may also be stored in a computer connected via a network such as the Internet so that it can be downloaded therefrom via the network. Further, the control program may be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk controller comprising:
a reader configured to execute a plurality of read operations with respect to a first area on the magnetic disk while offsetting a head configured to read data from the magnetic disk, when the reader retries reading data from a magnetic disk;
a selector configured to select data from a plurality of pieces of read data from results of the read operations based on a predetermined index with respect to each data length shorter than a data length of the area; and
a combining module configured to combine pieces of read data selected for the data lengths, respectively.

2. The disk controller of claim 1, wherein
the selector comprises:
a decoder configured to execute maximum likelihood decoding on the pieces of read data from the results of the read operations based on a Viterbi algorithm;
a storage module configured to store the pieces of read data decoded by the decoder;
a waveform calculator configured to convolute each piece of read data decoded by the decoder in order to calculate a waveform signal representing the read data before the maximum likelihood decoding; and
a difference calculator configured to calculate a difference between the waveform signal and the read data before the maximum likelihood decoding with respect to each piece of read data, and
the selector is configured to select the data based on the difference.

3. The disk controller of claim 2, wherein the difference calculator is configured to calculate a noise component as the difference from the waveform signal and the read data before the maximum likelihood decoding.

4. The disk controller of claim 2, wherein the difference calculator is configured to calculate a signal power as the difference from the waveform signal and the read data before the maximum likelihood decoding.

5. The disk controller of claim 2, wherein the difference calculator is configured to calculate a signal-to-noise ratio as the difference from the waveform signal and the read data before the maximum likelihood decoding.

6. The disk controller of claim 2, further comprising a filter configured to execute finite impulse response filtering on each piece of read data from the results of the read operations using a predetermined parameter, wherein
the decoder is configured to execute the maximum likelihood decoding on each piece of read data after the filtering based on the Viterbi algorithm, and
the waveform calculator is configured to convolute each piece of read data decoded by the decoder using the predetermined parameter used in the filtering in order to calculate the waveform signal representing the read data before the maximum likelihood decoding.

7. The disk controller of claim 1, wherein
the reader is configured to execute the read operations with respect to a physical sector as the area on the magnetic disk, and
the selector is configured to select the data with respect to each section of the physical sector.

8. A disk drive device comprising:
a magnetic disk;
a reader configured to execute a plurality of read operations with respect to a first area on the magnetic disk while offsetting a head configured to read data from the magnetic disk when the reader retries reading data from a magnetic disk;
a selector configured to select data from a plurality of pieces of read data from results of the read operations based on a predetermined index with respect to each data length shorter than a data length of the area; and
a combining module configured to combine pieces of read data selected for the data lengths, respectively.

9. A disk control method comprising:
reading a first area on the magnetic disk a plurality of times while offsetting a head that reads data from the magnetic disk in retrying reading data from a magnetic disk;
selecting data from a plurality of pieces of read data from results of the read operations based on a predetermined index with respect to each data length shorter than a data length of the area; and
combining pieces of read data selected for the data lengths, respectively.
